(19) United States
(12) Patent Application Publication
(10) Pub. No.: US 2008/0284070 A1
(43) Pub. Date: Nov. 20, 2008

(54) Leaf Spring Comprising an Upper and Lower Face with a Convex Cross-Section

(75) Inventors: Clemens Aulich, Magdeburg (DE); Rainer Forster, Odenthal-Voiswink (DE); Heiko Kempe, Magdeburg (DE)

Correspondence Address: Flindt Intellectual Property Law Group, PLLC, P.O. Box 1390, Issaquah, WA, 98027-0057, US

(73) Assignee: IFC COMPOSITE GMBH, Haldensleben (DE)

(21) Appl. No.: 12/093,327

(22) PCT Filed: Nov. 4, 2006
(86) PCT No.: PCT/DE2006/001938

§ 371 Date: May 19, 2008

(30) Foreign Application Priority Data
Nov. 11, 2005 (DE) DE 10 2005 054 33

(51) Int. Cl. F16F 1/368

(52) U.S. Cl. 267/47

(57) ABSTRACT

The invention relates to a leaf spring (1) consisting of a fibre-composite material for use in a vehicle. To prevent cracking or the escape of leaf spring material on the longitudinal edges (10) of said leaf spring (1) when the latter is fixed to a vehicle, according to the invention at least the upper face (13) and/or the lower face (14) of the leaf spring (1) are convex transversally to the longitudinal extension of said spring.

The invention relates to a leaf spring consisting of a fiber-composite material pursuant to the generic term of claim 1.

Leaf springs are commonly used for wheel suspensions in vehicles in order to provide cushioning against uneven road surfaces. Such vehicles may include, but are not limited to, passenger vehicles, trucks, and other utility vehicles, and may also include railcars and similar vehicles.

Leaf springs made of steel have been known for some time. In such springs, narrow steel sheets of decreasing lengths are placed on top of one another in order to achieve a variable spring constant with increasing load. The sheets of the leaf springs are joined into a unit by means of clamps and/or screws. When mounting a leaf spring on a vehicle, this is done transversely to the direction of travel, for example, wherein the center area of the leaf spring is specified on the vehicle chassis, while the two axial ends of the leaf springs are arrayed in the area of the suspension for the right and left vehicle wheels. Even though a metal leaf spring is comparatively more cost-effective to manufacture and more reliable in operation, nevertheless it has the disadvantage of being heavy, which contributes to a relatively high vehicle weight and thus ultimately causes higher fuel consumption.

Also known are leaf springs made of fiber-composite materials that are formed, for example, from glass or carbon fibers impregnated with synthetic resins, and which have comparable suspension properties with significantly less weight than steel leaf springs of the same size. Such fiber-composite leaf springs are manufactured, for example, from individual resin-impregnated fiber layers, known by the term “prepreg.”

These prepregs are manufactured in and/or cut to the desired form and placed on top of one another in a press mold that corresponds to the dimensions of the leaf spring. The unfinished leaf spring in the press mold is then cured using pressure and heat.

DE 102 21 589 A1 describes a leaf spring made of a fiber-composite material consisting of a single piece with a central arched section and peripheral sections on the ends. The peripheral sections have an eyelet on their respective axial ends with an opening to receive a bolt for the purpose of attaching the leaf spring to the vehicle chassis. The disadvantage of this lies in integrating the mounting eyelet into the leaf spring, which can be accomplished only with a structurally complex press mold or by a punching process that penetrates through the fibers.

In other leaf spring designs made of fiber-composite materials, the end sections are beveled. Here each end section is cut to the appropriate beveled form after the leaf spring is cured. As a result, the fibers of the material are also cut. With long-term variable loads on the leaf spring, the sites of the cuts often develop cracks that extend outward from the sites of the cuts and primarily run parallel to the longitudinal extension of the fibers. These cracks may in turn cause the leaf spring to break.

EP 0 093 707 B1 and the parallel U.S. Pat. No. 4,557,500 B1 describe a leaf spring made of fiber-composite material that is narrower and thicker on its axial ends than in a central, rectangular section. In this design, the area of the axial ends of the leaf spring can be somewhat trapezoidal in top view. According to another variant, the surface of the right-angle cross-sections of the leaf spring can be constant from one end of the spring to the other. In another structural type of this leaf spring, the composite fibers are uncut from one axial end to the other. The geometry of the leaf spring is created by press molds during its manufacture.

Also known from DE 10 2004 010 768 A1 of the applicant is a leaf spring made of a fiber-composite material with a central longitudinal extension and axial ends for a wheel suspension on a vehicle, in which the axial ends are formed tapering with respect to the leaf spring width, and in which the axially orientated fibers of the fiber-composite material extend the full length up to the terminal edge of the leaf spring. In addition, this leaf spring is made of resin-impregnated fiber layers that have an essentially V-shaped geometry or a V-shaped notch on the axial ends in top view during the manufacture of the leaf spring, and thus form two limbs lying transversally to the longitudinal extension of the leaf spring. These two limbs abut one another in the manufacturing process and are cured so that the final manufactured leaf spring is somewhat trapezoidal in the area of its ends, and has no thickening of the material in this area.

Also known from this publication is that the thickness of the leaf spring can be reinforced in its central area by means of geometrically simple, rectangular fiber layers, using fiber layers fashioned appropriately to form the V-shaped axial ends of the leaf spring and extending across the entire length of the part.

A leaf spring according to DE 10 2004 010 768 A1 has several advantages because it has essentially constant cross-section surfaces throughout almost its entire length as well as a constant thickness with a narrower width on the axial end, without having to be cut on its axial ends.

Structural studies on known leaf springs made of fiber-composite materials have shown that these do not always have the rectangular cross-section predetermined by a press mold. On the contrary, these leaf springs have upper and/or lower faces that are slightly concave transversally to the longitudinal extension, whereby the longitudinal edges of the leaf spring project somewhat upward or downward.

If such conventional leaf springs are affixed at their mounting points with related means of mounting on a part that is to be cushioned, then cracks form at the mounting points, or the edges of the leaf springs partially break off at these mounting/affixing points. Such cracks or breakage points have a detrimental effect on the service life of the leaf spring, because moisture can penetrate into these areas and negatively affect their bond structure.

The invention therefore relates to the improvement of a fiber-composite leaf spring so that the formation of cracks or even the breaking of an edge on the mounting points as described above does not occur.

The achievement of this object is shown by the features of claim 1. Advantageous embodiments and improvements of the invention are specified in the sub claims.

The invention is based upon the recognition that despite a rectangular shape-determining cross-section geometry of a press mold for the manufacture of a fiber-composite leaf spring, a non-rectangular cross-section geometry of the leaf spring may result. In particular, a concave upper and/or lower face is frequently formed. In order to counteract this, according to the invention a leaf spring is manufactured using a press mold with surfaces that have a concave cross-section at least for the upper face and the lower face of the leaf spring in order to permit the manufacture of a leaf spring with convex surfaces.

The invention therefore relates to a leaf spring made of a fiber-composite material, characterized in that at least its upper face and/or lower face are convex transversally to the longitudinal extension of said spring. When affixing said spring to related mounting fixtures on a vehicle, the edges of the leaf spring therefore no longer project upwards or downwards, and thus also can no longer tear and/or break off as a result of their mounting.

The fiber-composite leaf spring can also be advantageously formed with lateral surfaces having a convex cross-section, so that their edges have a particularly obtuse angle, which further reduces the risk of crack formation or the breaking off of edges.

The convex camber of at least the upper and/or lower face of the leaf spring is preferably formed such that the means of mounting that affix the leaf spring to a vehicle at least do not touch the edges of the leaf spring first when affixing it.

According to another improvement of the invention, at least the upper face and/or lower face of the leaf spring viewed longitudinally is convex and/or domed only in the area of its mounting points. This eliminates the need for increased use of material axially between the aforementioned affixing points.

The convex camber of at least the upper face and/or the lower face of the leaf spring can also be extended across the entire cross-section width or only in the area of the axially orientated edges of said spring.

The contact surfaces of the mounting fixtures that affix the leaf spring could of course also have a concave upper surface in order to achieve the same technical effect, i.e. the avoidance of crack formation and/or the breaking off of the longitudinal edges of the leaf spring. A direct contact of the edges of the leaf spring with the respective mounting fixture would then likewise not occur. Such mounting fixtures would be produced in a machining process, which is more complex than the molding process using the only slightly modified press mold for manufacturing the fiber-composite leaf spring.

A drawing is attached to the description in order to more clearly explain the invention. This shows

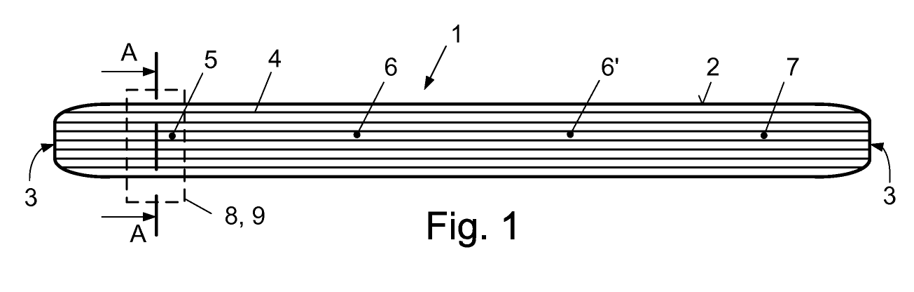

FIG. 1 a schematic top view of a leaf spring according to the invention.

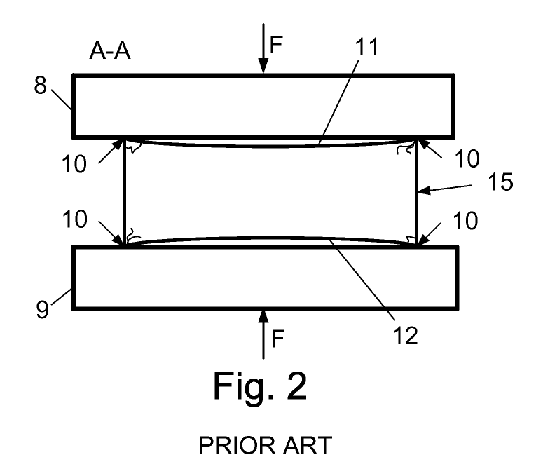

FIG. 2 a cross-section through the mounting area of a conventional leaf spring at point A-A according to FIG. 1 and through a corresponding mounting fixture, and

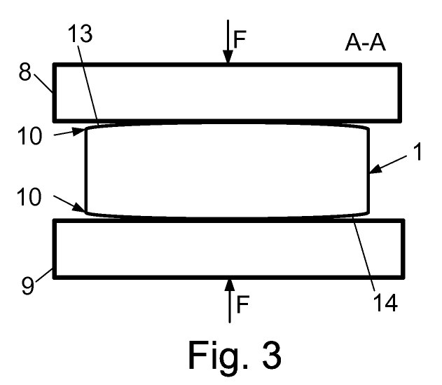

FIG. 3 a view as in FIG. 2, although with a leaf spring developed according to the invention.

FIG. 1 therefore shows a schematic top view of a leaf spring 1, which consists of a fiber-composite material and has a largely square, rod-shaped peripheral contour 2. The fiber-composite material essentially consists of fibers 4, such as glass, carbon, or aramide fibers, which are arrayed largely parallel to one another and which extend fully from one axial end 3 to the opposing axial end 3 of the leaf spring, and which are embedded in a cured synthetic resin. This leaf spring 1 is designed for installation in a vehicle, for example, such as a city delivery truck, in which it is arrayed transversally to the vehicle's longitudinal axis.

Leaf spring 1 can be joined to vehicle parts with its mounting areas 5, 6, 6′, and 7, wherein the axially external mounting areas 5 and 7 are customarily assigned to a wheel suspension of a left or right vehicle front wheel and the center mounting areas 6, 6′ to two eccentric mounting points on the vehicle chassis.

The mounting of a leaf spring 15 on the aforementioned vehicle parts according to the state of the art occurs as shown in simplified form in the cross-section view A-A according to FIG. 2. In this view, an initial means of mounting 8 is located in mounting area 5 on the upper face 11 and a second means of mounting 9 is located on lower face 12 of leaf spring 15 with application of a contact force F. Because leaf spring 15 is formed in the production process according to the state of the art with a slightly concave upper face 11 and/or slightly concave lower face 12, contact force F exerts an influence primarily on the longitudinal edges 10 of said spring during the initial load of leaf spring 15 such that these edges partially break off or at least form cracks, which is indicated in FIG. 2 and should be avoided.

FIG. 3 shows a cross-section A-A through leaf spring 1 according to the invention pursuant to FIG. 1. In this figure, it can be clearly seen that leaf spring 1 has a convex upper face 13 and a convex lower face 14. Here the camber and/or doming of the upper surfaces 13, 14 is preferably so slight that the edges 10 of leaf spring 1 are not the first to receive the load of contact force F, but instead a center area with a larger surface area receives the initial load. This avoids crack formation in the spring 1, and thus detectably extends its service life.

### DRAWING REFERENCE

1 Leaf spring
2 Peripheral contour of leaf spring
3 Axial end of leaf spring
4 Fibers
5 Lateral mounting area
6 Center mounting area
6′ Center mounting area
7 Lateral mounting area
8 Means of mounting
9 Means of mounting
10 Edge
11 Upper face of leaf spring, concave
12 Lower face of leaf spring, concave
13 Upper face of leaf spring, convex
14 Lower face of leaf spring, convex
15 Leaf spring, state-of-the-art
F Contact force

1. Leaf spring (1) made of a fiber-composite material, characterized in that at least the upper face (13) and/or lower face (14) of leaf spring (1) are convex transversally to the longitudinal extension of said spring.

2. Leaf spring according to claim 1, characterized in that the lateral surfaces of leaf spring (1) are also convex.

3. Leaf spring according to claim 1 or 2, characterized in that at least upper face (13) and/or lower face (14) of leaf spring (1) are convex only in their mounting areas (5, 6, 6′, 7).

4. Leaf spring according to at least one of claims 1 through 3, characterized in that the convex camber is shaped such that the means of mounting (8, 9) that affix leaf spring (1) to a vehicle at least do not touch the edges (10) of leaf spring (1) first when affixing it.

5. Leaf spring according to at least one of claims 1 through 4, characterized in that the convex camber of at least upper face (13) and lower face (14) can also be extended across the entire cross-section width of leaf spring (1) or only in the area of the edges (10).

6. Leaf spring according to at least one of claims 1 through 5, characterized in that the convex camber of at least upper face (13) and/or lower face (14) of leaf spring (1) is produced by a forming mold with concave mold surfaces.
